(19) United States
(12) Patent Application Publication
(10) Pub. No.: US 2012/0303182 A1
(43) Pub. Date: Nov. 29, 2012

(54) SYSTEM AND METHOD FOR MANAGING VEHICLE THROUGH THE WIRELESS COMMUNICATIONS RELAY OF A VEHICLE REMOTE CONTROLLER

(76) Inventor: In Ju Choi, Gyeonggi-do (KR)

(21) Appl. No.: 13/574,334

(22) PCT Filed: Dec. 29, 2010
(86) PCT No.: PCT/KR2010/009478

§ 371 Date: Jul. 20, 2012

(30) Foreign Application Priority Data
Jan. 20, 2010 (KR) 10-2010-0005025

(51) Int. Cl. G06F 17/00

(52) U.S. Cl. 701/2

(57) ABSTRACT

The present invention relates to a system and method for managing a vehicle through a wireless communications relay of a vehicle remote controller, which save additional communication costs by using an inexpensive and universal communication module such as a Bluetooth or Wi-Fi module instead of an existing mobile communication network, and are greatly economically beneficial and have high market adaptability by applying the existing communication module as-is to an existing mobile communication terminal and to an existing vehicle control means, in the management of the vehicle through a vehicle control terminal such as a mobile communication terminal capable of executing various applications. Especially for this purpose, the system for managing a vehicle through a wireless communications relay of a vehicle remote controller includes: a vehicle control terminal (100) provided with a first Bluetooth module (110) or a first Wi-Fi module therein for transmitting control data for controlling the vehicle as a vehicle control signal; a vehicle remote controller (200) provided with a second Bluetooth module (220) or a second Wi-Fi module therein for receiving the vehicle control signal, and provided with a first RF module (220) therein for transmitting the received vehicle control signal through the first RF module (220); and vehicle control means (300) built into the vehicle and provided with a second RF module (310) therein for receiving the vehicle control signal transmitted by the first RF module (220), so as to control the vehicle.

### TECHNICAL FIELD

The present invention relates, in general, to a vehicle management system using the wireless communication relay of a vehicle remote control. More particularly, the present invention relates to a vehicle management system and method using the wireless communication relay of a vehicle remote control, which assign the function of being able to communicate with some other terminal to a remote control in a vehicle remote starter alarm system composed of a vehicle controller and the remote control, thus allowing the corresponding vehicle to be controlled even by the other terminal.

### BACKGROUND ART

Generally, a vehicle remote control (a vehicle security system) is configured such that a separate device such as a controller is mounted in a vehicle and the vehicle remote control is connected to the wires or network of the vehicle via the separate device, thus checking the status of the vehicle (such as door open status, trunk open status, and starting status), and controlling the vehicle (such as the unlocking/locking of a door lock, the starting ON/OFF operation of an engine, and the ON/OFF operation of an emergency lamp).

In the case of a unidirectional system, when the remote control transmits control data, the controller that received the control data performs the corresponding operation. However, this system is disadvantageous in that it enables only control and does not provide a method of checking the current status of a vehicle.

In the case of a bidirectional system, a user can check even the status of the vehicle while the remote control and the controller are transmitting/receiving data, but there is a limitation in that only a limited amount of information can be displayed on the Liquid Crystal Display (LCD) panel or the Light Emitting Diode (LED) of the remote control used by the bidirectional system, and in that a means (for example, buttons) that can be provided on the user interface of the remote control is limited.

Meanwhile, recently, systems using mobile communication terminals to solve the above disadvantages have been developed and used. FIG. 1 is a diagram schematically showing a conventional vehicle control system using a key telecommunications network. As shown in FIG. 1, a mobile communication terminal 10 and a vehicle 20 perform wireless communication over a key telecommunications network. In this case, the mobile communication terminal 10 may be a mobile communication terminal having an application for remote control installed therein, and the vehicle 20 may be a vehicle control means mounted in the vehicle and capable of performing mobile communication.

This system is configured to remotely manage a vehicle anywhere over a mobile communication network in order to make up for the disadvantage that a vehicle remote control is operated within a relatively short range. However, since mobile communication subscribers who use such a mobile communication network must pay a separate communication fee or must pay a separate fee for a supplementary service, problems related to the expenses, apart from the convenience of use, make it difficult to anticipate that such a system will be activated.

Further, a system can be considered which controls and manages a vehicle using a method in which a mobile communication terminal and a vehicle control means directly perform wireless communication without utilizing a communication network. However, this is disadvantageous in that from the standpoint of a normal user who does not use such a system, the system may act as a factor leading to an unnecessary cost increase, and in that respective controllers mounted in vehicles use different protocols and different frequencies, thus making it difficult to standardize and commercialize the system.

Therefore, there has been an increased necessity for a vehicle management system which is capable of remotely and easily controlling and managing a vehicle without utilizing a key telecommunications network, while using a mobile communication terminal and the system of a remotely controllable vehicle without change.

### DISCLOSURE

### Technical Problem

Accordingly, the present invention has been made keeping in mind the above necessity, and an object of the present invention is to provide a vehicle management system and method using the wireless communication relay of a vehicle remote control, which manage a vehicle using various applications by employing a mobile communication terminal or the like as a vehicle control terminal and which do not utilize an existing mobile communication network.

Another object of the present invention is to provide a vehicle management system and method using the wireless communication relay of a vehicle remote control, in which the vehicle remote control can inherit the advantages of other devices, such as a smartphone or a computer, and utilize the advantages without change, and in which market adaptability can be improved based on the advantages.

### Technical Solution

In order to accomplish the above objects, the present invention provides a vehicle management system using wireless communication relay of a vehicle remote control, including a vehicle control terminal (100) configured to contain therein at least one of a first Bluetooth module (110) and a first Wireless-Fidelity (Wi-Fi) module and to transmit control data required to control a vehicle as a vehicle control signal; a vehicle remote control (200) configured to contain therein at least one of a second Bluetooth module (210) and a second Wi-Fi module and to receive the vehicle control signal and further configured to contain therein a first Radio Frequency (RF) module (220) and to transmit the received vehicle control signal via the first RF module (220); and vehicle control means (300) contained in the vehicle and configured to contain therein a second RF module (310) and to receive the vehicle control signal transmitted by the first RF module (220) and then control the vehicle.

Preferably, the control data may be data required to control a Body Control Unit (BCU) or an Electronic Control Unit (ECU) of the vehicle.

Preferably, the vehicle control terminal (100) may be any one of a mobile communication terminal, a computer, a Personal Digital Assistant (PDA), and an MP3 player.

Preferably, the vehicle control terminal (100) may further include an interface unit (120) for generating the control data.

Preferably, the control data may be generated by executing a management application of the vehicle via the interface unit (120).

Preferably, the first RF module (220) and the second RF module (310) may use a 300 to 500 MHz frequency band for wireless communication.

Preferably, each of the first Bluetooth module (110), the first Wi-Fi module, the second Bluetooth module (210), the second Wi-Fi module, the first RF module (220), and the second RF module (310) may be implemented as a transmission/reception module, the vehicle control means (300) transmits a control result signal corresponding to control result data resulting from control of the vehicle via the second RF module (310), the vehicle remote control (200) receives the control result signal via the first RF module (220) and transmits the control result signal via the second Bluetooth module (210) or the second Wi-Fi module, and the vehicle control terminal (100) receives the control result signal transmitted by the vehicle remote control (200) via the first Bluetooth module (110) or the first Wi-Fi module.

Preferably, the vehicle remote control (200) may further include a signal conversion unit (230) for converting the vehicle control signal received by the vehicle remote control (200) into an RF signal based on common layer data of the control data between any one of the second Bluetooth module (210) and the second Wi-Fi module and the first RF module (220).

Preferably, the signal conversion unit (230) may convert the control result signal received by the vehicle remote control (200) into any one of a Bluetooth signal and a Wi-Fi signal, based on the common layer data of the control result data.

Preferably, the vehicle remote control (200) may further include temporary storage means (250) for temporarily storing the control result data when a status of signal reception of the vehicle control terminal (100) is determined and the status indicates that signal reception is impossible.

Preferably, the vehicle remote control (200) may further include message notification means (260) for indicating the status of signal reception.

Preferably, the vehicle remote control (200) may further include encoding means (240) for encoding the control data, and the vehicle control means (300) may further include decoding means (320) for decoding the control data.

Further, in order to accomplish the above objects, the present invention provides a vehicle management method using wireless communication relay of a vehicle remote control, including a vehicle control terminal (100) transmitting control data required to control a vehicle as a vehicle control signal via a first Bluetooth module (110) or a first Wireless-Fidelity (Wi-Fi) module (S110); a vehicle remote control (200) receiving the vehicle control signal via a second Bluetooth module (210) or a second Wi-Fi module (S120); the vehicle remote control (200) transmitting the received vehicle control signal via a first RF module (220) (S130); and vehicle control means (300) receiving the vehicle control signal transmitted by the first RF module (220) via a second RF module (310) and then controlling the vehicle (S140).

Preferably, the control data may be generated by executing a management application of the vehicle via an interface unit (120).

Preferably, the vehicle management method may further include, after the vehicle control means (300) controlling the vehicle (S140), the vehicle control means (300) transmitting a control result signal corresponding to control result data resulting from control of the vehicle via the second RF module (310) (S160); the vehicle remote control (200) receiving the control result signal via the first RF module (220) (S170); the vehicle remote control (200) transmitting the control result signal via the second Bluetooth module (210) or the second Wi-Fi module (S180); and the vehicle control terminal (100) receiving the control result signal transmitted by the vehicle remote control (200) via the first Bluetooth module (110) or the first Wi-Fi module.

### Advantageous Effects

According to the embodiments of the present invention, there is an advantage in that when managing a vehicle using various applications that can be executed on a vehicle control terminal such as a mobile communication terminal, a relay function based on a communication module such as a Bluetooth module, instead of an existing mobile communication network, is used, thus obtaining economically high utilization.

Further, there is an advantage in that a data communication relay function is added to and used by a vehicle remote control, so that the vehicle remote control can be applied without change to existing mobile communication terminals and existing vehicle control means, thus improving market adaptability.

Furthermore, there is an advantage in that an LCD or the like required to notify a user of the status of a vehicle is removed from an existing vehicle remote control, and the vehicle remote control can be replaced by a vehicle control terminal, thus saving resources.

### DESCRIPTION OF DRAWINGS

FIG. 1 is a diagram schematically showing a conventional vehicle control system using a key telecommunications network;

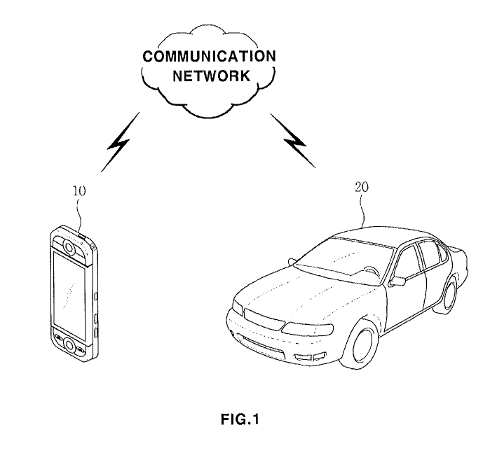

FIG. 2 is a diagram schematically showing an embodiment of a vehicle control system according to the present invention;

FIG. 3 is a diagram showing the configuration of a vehicle control system according to an embodiment of the present invention;

FIG. 4 is a flowchart sequentially showing the vehicle control signal transmission/reception procedure of a vehicle control method according to the present invention; and

FIG. 5 is a flowchart sequentially showing the control result signal transmission/reception procedure of the vehicle control method according to the present invention.

### DESCRIPTION OF REFERENCE CHARACTERS OF IMPORTANT PARTS

10: mobile communication terminal
20: vehicle control means
100: vehicle control terminal
110: first Bluetooth module
120: interface unit
130: management application storage means
200: vehicle remote control
210: second Bluetooth module
220: first RF module
230: signal conversion unit
240: encoding means
250: temporary storage means
260: message notification means
300: vehicle control means
310: second RF module
320: decoding means

### BEST MODE

### Embodiments

<Vehicle Management System>

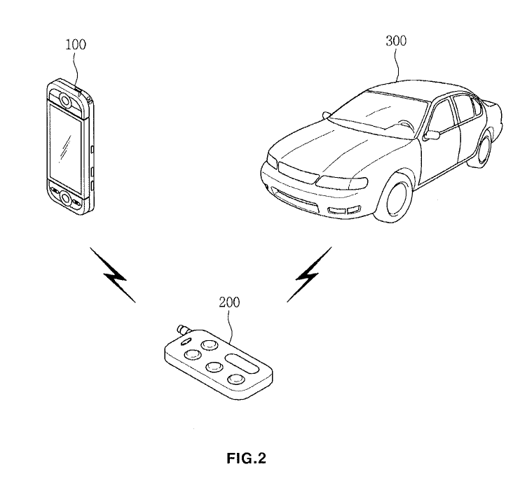

FIG. 2 is a diagram schematically showing an embodiment of a vehicle control system according to the present invention. As shown in FIG. 2, the present invention includes a vehicle control terminal 100, a vehicle remote control 200, and a vehicle control means 300. An operating mechanism according to an embodiment of the present invention will be described briefly. The vehicle control terminal 100 transmits a vehicle control signal using a Bluetooth module or a Wireless-Fidelity (Wi-Fi) module, and the vehicle remote control 200 that received the vehicle control signal transmits the vehicle control signal using a Radio Frequency (RF) module. The vehicle control means 300 equipped with an RF module receives the vehicle control signal and controls a Body Control Unit (BCU) for managing the starting or the like of the vehicle and various types of Electronic Control Units (ECUs).

Each of the Bluetooth module or the Wi-Fi module and the RF module may be a bidirectional communication module capable of performing transmission and reception. In this case, the case where status information about the vehicle is transmitted by the vehicle control means 300 to the vehicle control terminal 100 via the vehicle remote control 200 may be included.

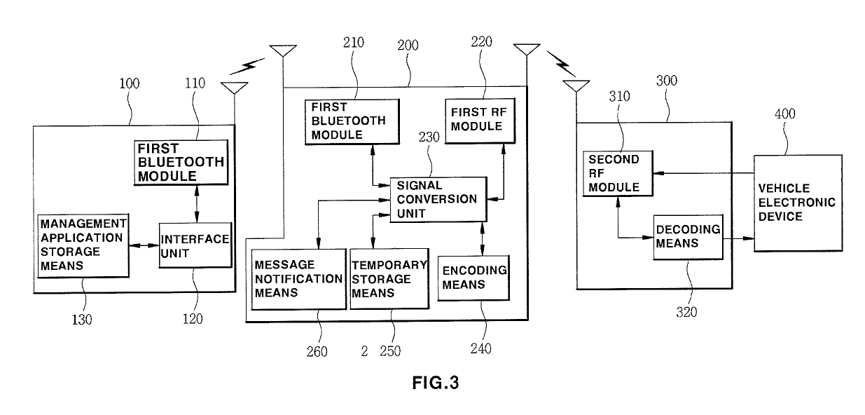

FIG. 3 is a diagram showing the configuration of a vehicle control system according to an embodiment of the present invention. As shown in FIG. 3, the vehicle control system according to the present invention includes a vehicle control terminal 100, a vehicle remote control 200, and a vehicle control means 300.

The vehicle control terminal 100 contains therein a first Bluetooth module 110 or a first Wi-Fi module (not shown), and functions to transmit control data required to control a vehicle as a vehicle control signal. The vehicle control terminal 100 may be a computer, a Personal Digital Assistant (PDA), or an MP3 player, in addition to a mobile communication terminal such as a smartphone.

Further, the control data may be data required to control the BCU, such as for the remote starting of the vehicle, or data required to control the ECUs of the vehicle. The vehicle control terminal 100 may further include an interface unit 120 to generate and edit control data.

The control data may be generated by loading a management application from a management application storage means 130 contained in the vehicle control terminal 100 and executing the management application. The management application may be any of various management applications such as applications for remote starting ON/OFF of the vehicle, security alarm notification setup, door opening/closing, trunk opening, discharge alarm setup, and code unlock. Further, such a management application may be downloaded from online by a terminal user and stored in the management application storage means 130 or, alternatively, may be internally installed in the vehicle control terminal 100 when the vehicle control terminal 100 is manufactured.

The first Bluetooth module 110 functions to transmit and receive a vehicle control signal and a control result signal in a relationship with a second Bluetooth module 210. In this case, the Bluetooth modules 110 and 210 are short-range wireless communication modules, and have a use frequency and module configuration that are different from those of the RF module 220 of the vehicle remote control 200 that uses a 300 to 500 MHz frequency band, because of their communication standards that use a 2.4 GHz frequency band, thus making it impossible to perform transmission and reception with the RF module 220.

The Bluetooth modules 110 and 210 function as a master and a slave when being in transmission and reception stages depending on the protocol stack flow of Bluetooth. When transmission and reception are performed bidirectionally, each Bluetooth module sequentially transfers a Host Controller Interface (HCI)-write scan enable command, an HCI-inquiry command, etc. in the sequence of a Service Discovery Protocol (SDP), a Logical Link Control and Adaptation Protocol (L2CAP), and a Host Controller Interface (HCI), thus enabling master and slave functions to be exchanged.

Although the Wi-Fi module is not shown in the drawing, it is a modification of the Bluetooth modules 110 and 210, and is configured to be contained in each of the vehicle control terminal 100 and the vehicle remote control 200 that are components of the present invention and to be capable of transmitting and receiving a vehicle control signal and a control result signal.

The Wi-Fi module adopts a Wireless Local Area Network (WLAN) technology based on IEEE 802.11 standards, and includes principal standards such as 802.11a, 802.11b, 802.11g, and 802.11n. Most smartphones that have recently been released comply with IEEE 802.11b/g standards, and 802.11n is a standard required when the frequency bands of both 2.4 GHz and 5 GHz are used, so that the Wi-Fi module has a use frequency and module configuration that are different from those of the RF module 220 of the vehicle remote control 200 that uses a 300 to 500 MHz frequency band, thus making it impossible to perform transmission and reception with the RF module.

The vehicle remote control 200 contains therein the second Bluetooth module 210 or the second Wi-Fi module to function to receive a vehicle control signal, and also contains therein the first RF module 220 to function to transmit the received vehicle control signal via the first RF module 220. Further, the vehicle remote control 200 may also function to receive a control result signal corresponding to control result data resulting from the control of the vehicle from the vehicle control means 300, and transmit the control result signal to the vehicle control terminal 100. In this case, the control result data is data indicative of the control status of the vehicle.

The vehicle remote control 200 may be configured to further include a temporary storage means 250, which is required to temporarily store control result data, when the status of the signal reception of the vehicle control terminal 100 is determined and the status indicates that signal reception is impossible. In this case, the vehicle remote control 200 may further include a message notification means 260 for indicating the status of signal reception, thus indicating the status of waiting for a transmission.

The vehicle remote control 200 further includes an encoding means 240 for encoding control data so as to authenticate a normal vehicle user, and the vehicle control means 300 further includes a decoding means 320 for decoding the encoded control data.

The vehicle remote control 200 must be provided with both the Bluetooth module for performing transmission and reception with the vehicle control terminal 100 and the RF module for performing transmission and reception with the vehicle control means 300, and also must perform data transmission and signal conversion between the modules.

Therefore, a signal conversion unit 230 for converting a vehicle control signal into an RF signal based on the common layer data of control data is further included between the second Bluetooth module 210 and the first RF module 220. Such a signal conversion unit 230 is equipped with a microcomputer and is configured to control the conversion of communication signals and also control the corresponding control data and the control result data.

As described above, the Bluetooth module may be replaced by a Wi-Fi module that is a modification of the Bluetooth module, in which case the signal conversion unit 230 is a means for performing signal conversion between Wi-Fi signals and RF signals.

Further, the signal conversion unit 230 is configured to, when a control result signal corresponding to a vehicle control signal is received from the vehicle control means 300, convert the vehicle control signal, that is, an RF signal, into any one of a Bluetooth signal and a Wi-Fi signal, based on the common layer data of the control result data corresponding to the control result signal.

The vehicle control means 300 is contained in the vehicle, and contains therein a second RF module 310 to function to receive the vehicle control signal transmitted by the first RF module 220 and control the vehicle. Here, a target to be controlled is a vehicle electronic device 400, which corresponds to the BCU or various types of ECUs of a vehicle.

<Vehicle Management Method>

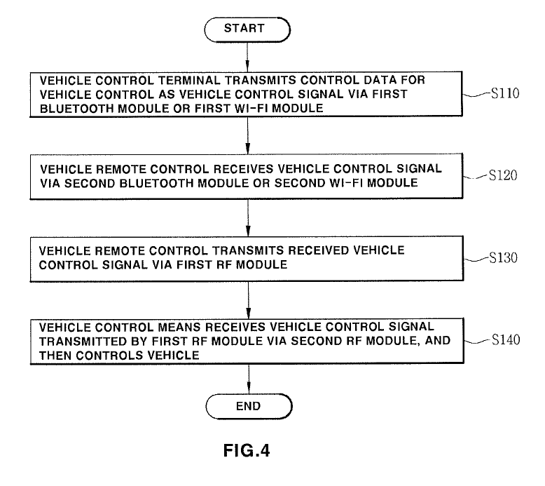

FIG. 4 is a flowchart sequentially showing the vehicle control signal transmission/reception procedure of a vehicle control method according to the present invention. Referring to FIG. 4, the vehicle control terminal 100 transmits control data required to control the vehicle as a vehicle control signal via the first Bluetooth module 110 or the first Wi-Fi module (S110).

In this case, the control data is the data required to control the BCU or ECUs of the vehicle, wherein the control data is obtained by loading a management application from the management application storage means 130 of the vehicle control terminal 100 and is generated or edited via the interface unit 120.

Next, the vehicle remote control 200 receives the vehicle control signal via the second Bluetooth module 210 or the second Wi-Fi module (S120).

Next, the vehicle remote control 200 transmits the received vehicle control signal via the first RF module 220 (S130).

Then, the vehicle control means 300 receives the vehicle control signal transmitted by the first RF module 220 via the second RF module 310 and controls the vehicle (S140), so that the vehicle management method using the wireless communication relay of the vehicle remote control 200 according to the present invention is performed.

In this case, the step S125 of the signal conversion unit 230 converting the vehicle control signal into an RF signal based on the common layer data of control data between any one of the second Bluetooth module 210 and the second Wi-Fi module and the first RF module 220 may be further included between the vehicle control signal reception step (S120) performed by the vehicle remote control 200 and the vehicle control signal transmission step (S130) performed by the vehicle remote control 200.

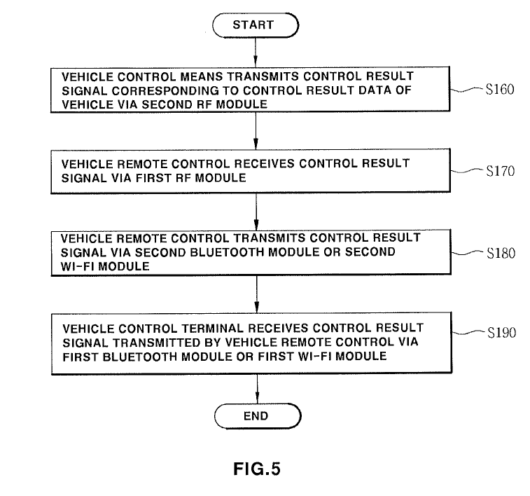

Meanwhile, the case where the vehicle remote control 200 receives a control result signal corresponding to the vehicle control signal from the vehicle control means 300 and transmits it to the vehicle control terminal 100 will be described with reference to FIG. 5.

FIG. 5 is a flowchart sequentially showing the control result signal transmission/reception procedure of the vehicle control method according to the present invention. Referring to FIG. 5, the vehicle control means 300 transmits a control result signal corresponding to control result data resulting from the control of the vehicle via the second RF module 310 (S160).

Next, the vehicle remote control 200 receives the control result signal via the first RF module 220 (S170).

Thereafter, the vehicle remote control 200 transmits the control result signal via the second Bluetooth module 210 or the second Wi-Fi module (S180).

Then, the vehicle control terminal 100 receives the control result signal transmitted by the vehicle remote control 200 via the first Bluetooth module 110 or the first Wi-Fi module (S190), so that the vehicle management method using the wireless communication relay of the vehicle remote control 200 according to the present invention is performed. Of course, the received control result signal is displayed on the vehicle control terminal 100, so that the user can check the status of the vehicle.

In this case, the step S175 of the signal conversion unit 230 converting the vehicle control signal into a Bluetooth signal based on the common layer data of the control result data corresponding to the control result signal may be included between the control result signal reception step (S170) and the control result signal transmission step (S180) performed by the vehicle remote control 200.

Of course, when a Wi-Fi module (not shown) that is a modification of the above-described Bluetooth modules 110 and 210 is used, the conversion of a Bluetooth signal may be replaced by the conversion of a Wi-Fi signal.

Although the embodiments of the present invention have been disclosed with reference to the attached drawings, it should be understood that those skilled in the art can implement the present invention in other detailed forms without changing the technical spirit or essential features of the invention. Therefore, the above-described embodiments should be understood to be exemplary from all aspects rather than restrictive. Furthermore, the scope of the present invention is defined by the accompanying claims rather than by the detailed description of the invention. Furthermore, all the changes or modifications derived from the meanings, scopes, and equivalents of the claims should be interpreted as being included in the scope of the present invention.

1. A vehicle management system using wireless communication relay of a vehicle remote control, comprising:
a vehicle control terminal (100) configured to contain therein at least one of a first Bluetooth module (110) and a first Wireless-Fidelity (Wi-Fi) module and to transmit control data required to control a vehicle as a vehicle control signal;
a vehicle remote control (200) configured to contain therein at least one of a second Bluetooth module (210) and a second Wi-Fi module and to receive the vehicle control signal and further configured to contain therein a first Radio Frequency (RF) module (220) and to transmit the received vehicle control signal via the first RF module (220); and
vehicle control means (300) contained in the vehicle and configured to contain therein a second RF module (310) and to receive the vehicle control signal transmitted by the first RF module (220) and then control the vehicle.

2. The vehicle management system of claim 1, wherein the control data is data required to control a Body Control Unit (BCU) or an Electronic Control Unit (ECU) of the vehicle.

3. The vehicle management system of claim 1, wherein the vehicle control terminal (100) is any one of a mobile communication terminal, a computer, a Personal Digital Assistant (PDA), and an MP3 player.

4. The vehicle management system of claim 1, wherein the vehicle control terminal (100) further comprises an interface unit (120) for generating the control data.

5. The vehicle management system of claim 4, wherein the control data is generated by executing a management application of the vehicle via the interface unit (120).

6. The vehicle management system of claim 1, wherein the first RF module (220) and the second RF module (310) use a 300 to 500 MHz frequency band for wireless communication.

7. The vehicle management system of claim 1, wherein:
each of the first Bluetooth module (110), the first Wi-Fi module, the second Bluetooth module (210), the second Wi-Fi module, the first RF module (220), and the second RF module (310) is implemented as a transmission/reception module,
the vehicle control means (300) transmits a control result signal corresponding to control result data resulting from control of the vehicle via the second RF module (310),
the vehicle remote control (200) receives the control result signal via the first RF module (220) and transmits the control result signal via the second Bluetooth module (210) or the second Wi-Fi module, and
the vehicle control terminal (100) receives the control result signal transmitted by the vehicle remote control (200) via the first Bluetooth module (110) or the first Wi-Fi module.

8. The vehicle management system of claim 7, wherein the vehicle remote control (200) further comprises a signal conversion unit (230) for converting the vehicle control signal received by the vehicle remote control (200) into an RF signal based on common layer data of the control data between any one of the second Bluetooth module (210) and the second Wi-Fi module and the first RF module (220).

9. The vehicle management system of claim 8, wherein the signal conversion unit (230) converts the control result signal received by the vehicle remote control (200) into any one of a Bluetooth signal and a Wi-Fi signal, based on the common layer data of the control result data.

10. The vehicle management system of claim 7, wherein the vehicle remote control (200) further comprises temporary storage means (250) for temporarily storing the control result data when a status of signal reception of the vehicle control terminal (100) is determined and the status indicates that signal reception is impossible.

11. The vehicle management system of claim 10, wherein the vehicle remote control (200) further comprises message notification means (260) for indicating the status of signal reception.

12. The vehicle management system of claim 1, wherein:
the vehicle remote control (200) further comprises encoding means (240) for encoding the control data, and
the vehicle control means (300) further comprises decoding means (320) for decoding the control data.

13. A vehicle management method using wireless communication relay of a vehicle remote control, comprising:
a vehicle control terminal (100) transmitting control data required to control a vehicle as a vehicle control signal via a first Bluetooth module (110) or a first Wireless-Fidelity (Wi-Fi) module (S110);
a vehicle remote control (200) receiving the vehicle control signal via a second Bluetooth module (210) or a second Wi-Fi module (S120);
the vehicle remote control (200) transmitting the received vehicle control signal via a first RF module (220) (S130); and
vehicle control means (300) receiving the vehicle control signal transmitted by the first RF module (220) via a second RF module (310) and then controlling the vehicle (S140).

14. The vehicle management method of claim 13, wherein the control data is generated by executing a management application of the vehicle via an interface unit (120).

15. The vehicle management method of claim 13, further comprising, after the vehicle control means (300) controlling the vehicle (S140):
the vehicle control means (300) transmitting a control result signal corresponding to control result data resulting from control of the vehicle via the second RF module (310) (S160);
the vehicle remote control (200) receiving the control result signal via the first RF module (220) (S170);
the vehicle remote control (200) transmitting the control result signal via the second Bluetooth module (210) or the second Wi-Fi module (S180); and
the vehicle control terminal (100) receiving the control result signal transmitted by the vehicle remote control (200) via the first Bluetooth module (110) or the first Wi-Fi module.
